(19) United States
(12) Patent Application Publication
(10) Pub. No.: US 2021/0089944 A1
(43) Pub. Date: Mar. 25, 2021

(54) OPTIMIZING GENERATION OF A FORECAST

(71) Applicant: Accenture Global Solutions Limited, Dublin (IE)

(72) Inventors: Lijuan Marissa ZHOU, Dublin (IE); Chen LIU, Xian (CN); Qirun CHEN, Dublin (IE)

(21) Appl. No.: 16/807,938

(22) Filed: Mar. 3, 2020

(30) Foreign Application Priority Data
Sep. 25, 2019 (CN) PCTCN2019107903

(51) Int. Cl. G06N 5/04; G06N 20/00; G06Q 10/04; G06Q 40/02

(52) U.S. Cl. CPC G06N 5/04; G06Q 40/02; G06Q 10/04; G06N 20/00

(57) ABSTRACT

A device may receive a first set of historical financial data, a second set of historical financial data, and a plurality of machine learning models. The device may determine a respective forecasted financial score associated with each of the plurality of machine learning models based on the first set of historical financial data and the second set of historical financial data. The device may select two or more machine learning models from the plurality of machine learning models based on the respective forecasted financial score and may determine a set of evaluation data. The device may select an optimum machine learning model from the two or more machine learning models based on a comparison of the respective forecasted financial score of each of the two or more machine learning models relative to the set of evaluation data.

### CROSS-REFERENCE TO RELATED APPLICATION

This application claims priority to Patent Cooperation Treaty (PCT) Application No. PCT/CN2019/107903, filed Sep. 25, 2019, the contents of which are incorporated by reference herein.

### BACKGROUND

One or more machine learning models may be utilized to generate a prediction concerning one or more parameters. In some cases, a combination of one or more other machine learning models may be able to provide a more accurate prediction concerning the one or more parameters.

### SUMMARY

According to some implementations, a method may include receiving, by a device, a first set of historical financial data; receiving, by the device, a second set of historical financial data; obtaining, by the device, a plurality of machine learning models; determining, by the device, a respective forecasted financial score associated with each of the plurality of machine learning models based on the first set of historical financial data and the second set of historical financial data; selecting, by the device, two or more machine learning models from the plurality of machine learning models based on the respective forecasted financial score; determining, by the device, a set of evaluation data based on a time parameter of the first set of historical financial data and based on a time parameter of the second set of historical financial data; and selecting, by the device, an optimum machine learning model from the two or more machine learning models based on a comparison of the respective forecasted financial score of each of the two or more machine learning models relative to the set of evaluation data.

According to some implementations, a device may include one or more memories; and one or more processors, communicatively coupled to the one or more memories, configured to: receive a first set of historical financial data; receive a second set of historical financial data; obtain a plurality of machine learning models; determine a respective forecasted financial score associated with each of the plurality of machine learning models based on the first set of historical financial data and the second set of historical financial data; select two or more machine learning models from the plurality of machine learning models based on the respective forecasted financial score; determine a set of evaluation data based on a time parameter of the first set of historical financial data and based on a time parameter of the second set of historical financial data; and select an optimum machine learning model from the two or more machine learning models based on a comparison of the respective forecasted financial score of each of the two or more machine learning models relative to the set of evaluation data.

According to some implementations, a non-transitory computer-readable medium may store one or more instructions. The one or more instructions, when executed by one or more processors of a device, may cause the one or more processors to: receive a first set of historical financial data; receive a second set of historical financial data; obtain a plurality of machine learning models; determine a respective forecasted financial score associated with each of the plurality of machine learning models based on the first set of historical financial data and the second set of historical financial data; select two or more machine learning models from the plurality of machine learning models based on the respective forecasted financial score; determine a set of evaluation data based on a time parameter of the first set of historical financial data and based on a time parameter of the second set of historical financial data; and select an optimum machine learning model from the two or more machine learning models based on a comparison of the respective forecasted financial score of each of the two or more machine learning models relative to the set of evaluation data.

### BRIEF DESCRIPTION OF THE DRAWINGS

FIGS. 1A-1E are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-7 are flow charts of example processes for optimizing generation of a forecast.

### DETAILED DESCRIPTION

The following detailed description of example implementations refers to the accompanying drawings. The same reference numbers in different drawings may identify the same or similar elements.

Sometimes, a manager of a transaction account may need to make a prediction concerning one or more parameters associated with the transaction account. For example, a manager of a financial transaction account may need to estimate future ending cash values of the financial transaction account (e.g., daily ending cash values, weekly ending cash values, monthly ending cash values, quarterly ending cash values, and/or the like). In some cases, the manager may use a device that utilizes a set of one or more machine learning models to generate a forecast concerning the one or more parameters. However, in many cases, the forecast may not be accurate. This may cause the manager to use resources (e.g., processing resources, memory resources, power resources, communication resources, and/or the like) of one or more devices, such as a user device, a server device, a networking device, and/or the like to manage the transaction account and/or resources associated with the transaction account in an ineffective and/or inefficient manner.

Some implementations described herein provide a forecast analysis platform that may process historical data to train one or more machine learning models and may generate, utilizing the one or more machine learning models, a plurality of initial forecasts associated with a transaction account. In some implementations, the forecast analysis platform may determine, based on at least some of the plurality of initial forecasts, a plurality of forecasts concerning a parameter associated with the transaction account. In some implementations, the forecast analysis platform may evaluate the plurality of forecasts and determine that a particular forecast, of the plurality of forecasts, has a best fit with evaluation data. In some implementations, the forecast analysis platform may update at least one machine learning model that was used to generate the particular forecast and may generate an additional forecast concerning the parameter using the at least one machine learning model. In some implementations, the forecast analysis platform, based on generating the additional forecast, may perform one or more actions, such as sending the additional forecast to an additional device to allow the additional device to display the additional forecast on a display of the additional device.

In this way, the forecast analysis platform may optimize generation of a forecast concerning a parameter that is associated with a transaction account, which may provide a more accurate forecast than would otherwise be generated. This may reduce a demand for resources (e.g., processing resources, memory resources, power resources, communication resources, and/or the like) that would otherwise be used by one or more devices to manage the transaction account and/or resources associated with the transaction account. For example, the forecast analysis platform may generate a forecast that is more accurate than any other device could generate, which decreases a likelihood that budgets, reports, and/or the like concerning the transaction account would need to be modified. Moreover, the forecast analysis platform may perform an action, such as automatically scheduling transactions, which may reduce a need for a manager to monitor the transaction account using the one or more devices.

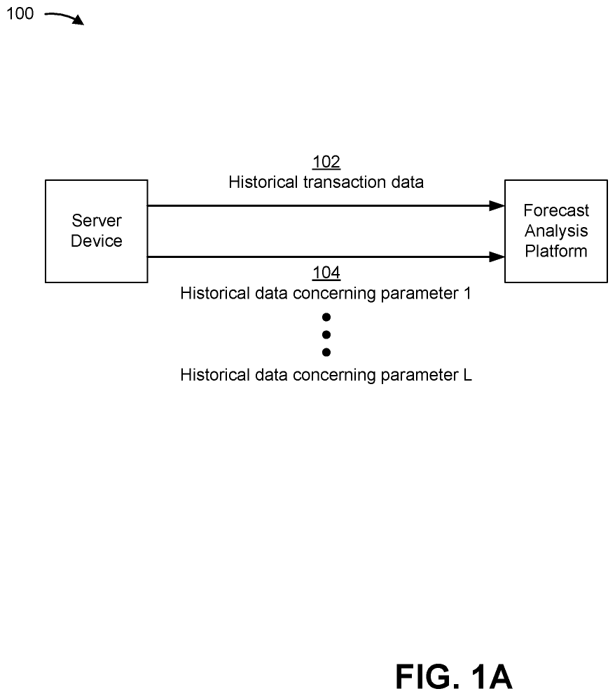

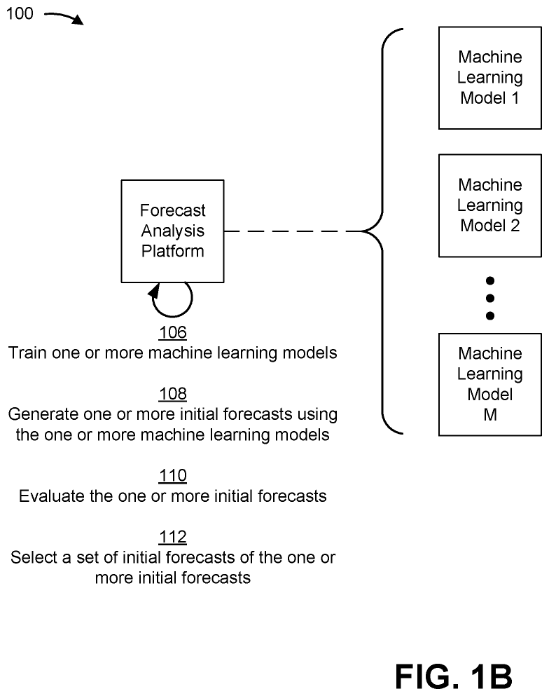

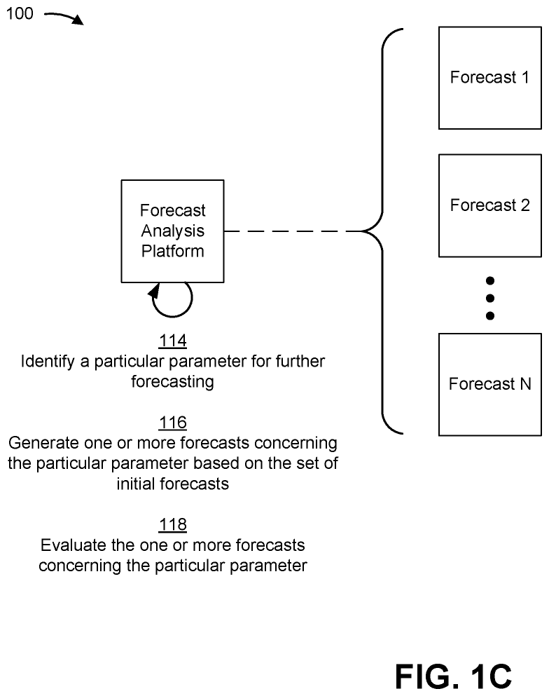

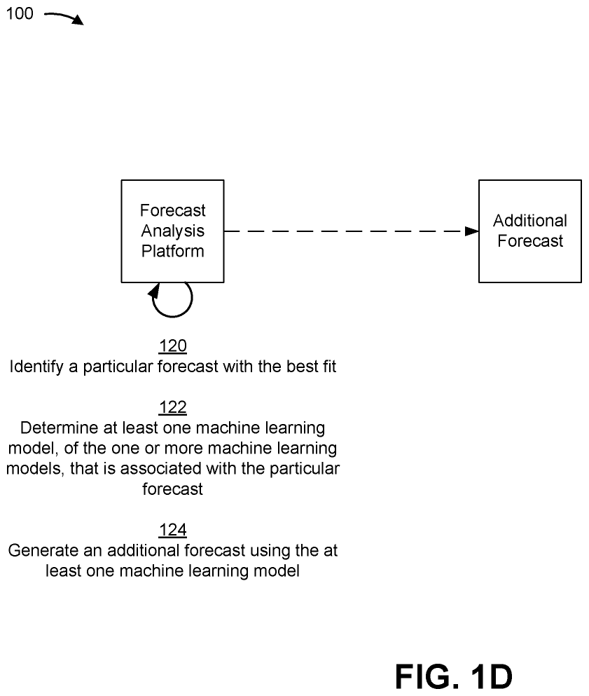

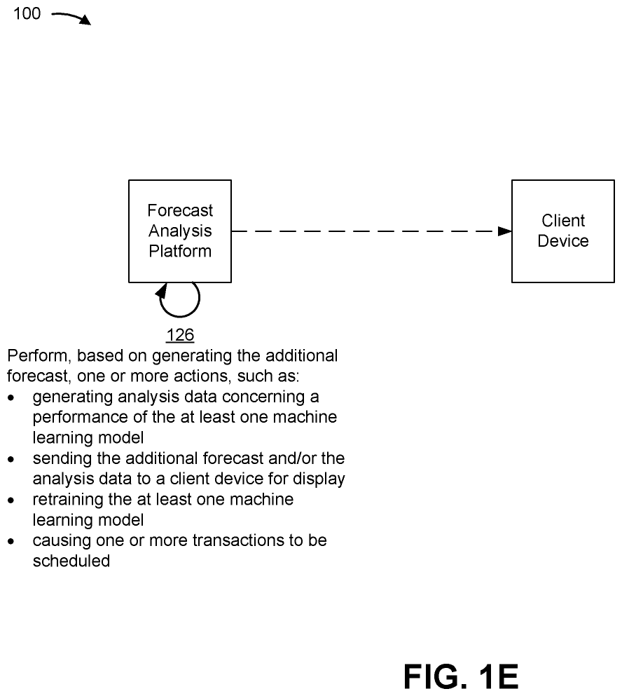

FIGS. 1A-1E are diagrams of one or more example implementations 100 described herein. As shown in FIGS. 1A-1E, example implementation(s) 100 may include a server device, a forecast analysis platform, and/or a client device. In some implementations, the server device, the client device, and/or the forecast analysis platform may be connected via a network, such as a wired network (e.g., the Internet or another data network), a wireless network (e.g., a wireless local area network, a wireless wide area network, a cellular network, etc.), and/or the like. Some example implementations described herein concern a single server device, a single client device, and/or a single forecast analysis platform, but implementations can include a plurality of server devices, a plurality of client devices, and/or a plurality of forecast analysis platforms.

In some implementations, the forecast analysis platform may obtain historical data from the server device. The historical data may relate to transactions associated with a transaction account (e.g., an electronic message transaction account, a network service transaction account, a financial transaction account, and/or the like). As shown in FIG. 1A and by reference number 102, the forecast analysis platform may obtain historical transaction data associated with the transaction account from the server device. For example, the server device may send the historical transaction data to the forecast analysis platform and/or the forecast analysis platform may request and receive the historical transaction data from the server device.

The historical transaction data may include information concerning one or more different transaction types. For example, when the historical transaction data is associated with a financial transaction account, the historical transaction data may include information concerning receipts of the transaction account (e.g., collections, interest income, and/or the like), disbursements of the transaction account (e.g., disbursements, payroll expenses, payroll taxes, bank fees, other taxes, interest expenses, and/or the like), indirect changes of the transaction account (e.g., foreign currency exchange gains or losses and/or the like). The historical transaction data may be associated with a period of time (e.g., a number of years, such as 3 years).

As shown by reference number 104, the forecast analysis platform may obtain historical data concerning one or more parameters (e.g., one or more parameters associated with the transaction account) from the server device (shown in FIG. 1A as historical data concerning parameter 1 through parameter L, where L is greater than or equal to 1). For example, the server device may send the historical data concerning the one or more parameters to the forecast analysis platform and/or the forecast analysis platform may request and receive the historical data concerning the one or more parameters from the server device.

The historical data concerning the one or more parameters may include information concerning the one or more parameters for the period of time (e.g., the period of time associated with the historical transaction data). For example, when a parameter is an ending cash value (also referred to herein as a cash balance) of a financial transaction account, the historical data concerning the one or more parameters may include information concerning daily, weekly, monthly, quarterly, and/or the like ending cash values of the financial transaction account for the period of time. As another example, when the parameter is a transaction amount of the financial transaction account (e.g., a difference between an ending cash value at one point in time period and an ending cash value at a second point in time), the historical data concerning the one or more parameters may include information concerning daily, weekly, monthly, quarterly, and/or the like transaction amounts of the financial transaction account for the period of time. In some implementations, the historical data concerning the one or more parameters may be derived from other historical information obtained from the server device, such as historical balance data associated with the transaction account.

As shown in FIG. 1B and by reference number 106, the forecast analysis platform may obtain or generate and/or train one or more machine learning models (shown in FIG. 1A as machine learning models 1 through M, where M is greater than or equal to 1). The forecast analysis platform may generate and/or train the one or more machine learning models based on the historical data obtained from the server device (e.g., the historical transaction data and/or the historical data concerning the one or more parameters). In some implementations, the one or more or machine learning models may include a seasonal autoregressive integrated moving average (SARIMA) machine learning model; a seasonal autoregressive integrated moving average with exogenous variables (SARIMAX) machine learning model; a long short-term memory (LSTM) machine learning model; an exponential smoothing machine learning model; a business logic machine learning model; a naïve machine learning model; and/or the like.

In some implementations, the forecast analysis platform may generate and/or train a first set of machine learning models, of the one or more machine learning models, to generate a first type of forecast; a second set of machine learning models to generate a second type of forecast; a third set of machine learning model to generate a third type of forecast; and/or the like. For example, the forecast analysis platform may generate and/or train each machine learning model of the first set of machine learning models to generate a forecast concerning a first parameter associated with a transaction account (e.g., a forecast concerning an ending cash value associated with a financial transaction account). As another example, the forecast analysis platform may generate and/or train each machine learning model of the second set of machine learning models to generate a forecast concerning a second parameter associated with the transaction account (e.g., a forecast concerning a transaction amount associated with the financial transaction account). In another example, the forecast analysis platform may generate and/or train each machine learning model of the third set of machine learning models to generate a forecast concerning transaction data associated with the transaction account (e.g., a forecast concerning one or more transaction types associated with the financial transaction account, such as a forecast concerning receipts of the financial transaction account, disbursements of the financial transaction account, indirect changes of the financial transaction account, and/or the like).

In some implementations, the forecast analysis platform may train a machine learning model, of the one or more machine learning models, using the historical data (e.g., the historical transaction data and/or the historical data concerning the one or more parameters) obtained by the forecast analysis platform from the server device. For example, the forecast analysis platform may divide the historical data into a first portion of historical data and a second portion of historical data. The first portion of historical data may be associated with a first period of time (also referred to herein as a first time parameter) and the second portion may be associated with a second period of time (also referred to herein as a second time parameter) that occurs after the first period of time (e.g., the first period of time may be associated with a 2 year period of time and the second period of time may be associated with a 1 year period of time that occurs after the first period of time). The forecast analysis platform may process the first portion of historical data (also referred to herein as training data) to train a machine learning model and may use the second portion of historical data to evaluate predictions generated by the machine learning model, as described herein (e.g., in relation to reference numbers 110 and 118).

When training the machine learning model, the forecast analysis platform may utilize a random forest classifier technique to train the machine learning model. For example, the forecast analysis platform may utilize a random forest classifier technique to construct multiple decision trees during training and may output a classification of the training data. As another example, the forecast analysis platform may utilize a random forest regression technique to construct multiple decision trees during training and may output a numeric predication associated with the training data. Additionally, or alternatively, when training the machine learning model, the forecast analysis platform may utilize one or more gradient boosting techniques to generate the machine learning model. For example, the forecast analysis platform may utilize an xgboost classifier technique, an xgboost regression technique, a gradient boosting machine (GBM) technique, a gradient boosting tree, and/or the like to generate a prediction model from a set of weak prediction models.

When training the machine learning model, the forecast analysis platform may utilize a logistic regression technique to train the machine learning model. For example, the behavioral analytics platform may utilize a binary classification of the training data (e.g., whether the training data is indicative of a particular accurate prediction), a multi-class classification of the training data (e.g., whether the training data is indicative of one or more accurate predictions), and/or the like to train the machine learning model. Additionally, or alternatively, when training the machine learning model, the forecast analysis platform may utilize a naïve Bayes classifier technique to train the machine learning model. For example, the forecast analysis platform may utilize binary recursive partitioning to divide the training data into various binary categories (e.g., starting with whether the training data is indicative of a particular accurate prediction). Based on using recursive partitioning, the forecast analysis platform may reduce utilization of computing resources relative to manual, linear sorting and analysis of data points, thereby enabling use of thousands, millions, or billions of data points to train a machine learning model, which may result in a more accurate machine learning model than using fewer data points.

Additionally, or alternatively, when training the machine learning model, the forecast analysis platform may utilize a support vector machine (SVM) classifier technique. For example, the forecast analysis platform may utilize a linear model to implement non-linear class boundaries, such as via a max margin hyperplane. Additionally, or alternatively, when utilizing the SVM classifier technique, the forecast analysis platform may utilize a binary classifier to perform a multi-class classification. Use of an SVM classifier technique may reduce or eliminate overfitting, may increase a robustness of the machine learning model to noise, and/or the like.

In some implementations, the forecast analysis platform may train the machine learning model using a supervised training procedure. In some implementations, the forecast analysis platform may receive additional input to the machine learning model from a subject matter expert. In some implementations, the forecast analysis platform may use one or more other model training techniques, such as a neural network technique, a latent semantic indexing technique, and/or the like. For example, the forecast analysis platform may perform a multi-layer artificial neural network processing technique (e. g, using a recurrent neural network architecture, a two-layer feedforward neural network architecture, a three-layer feedforward neural network architecture, and/or the like) to perform pattern recognition with regard to patterns in the training data. In this case, use of the artificial neural network processing technique may improve an accuracy of a supervised learning model generated by the forecast analysis platform by being more robust to noisy, imprecise, or incomplete data, and by enabling the forecast analysis platform to detect patterns and/or trends undetectable to human analysts or systems using less complex techniques. Furthermore, when using a recurrent neural network architecture, long short-term memory (LSTM) may be employed to classify, make predictions, and/or otherwise process time-series data, which may be useful to predict how patterns change over time (e.g., over a month, a year, and/or the like).

As shown by reference number 108, the forecast analysis platform may generate one or more initial forecasts associated with a transaction account (e.g., using the one or more machine learning models). For example, the forecast analysis platform may process the first portion of historical data, using at least one machine learning model of the one or more machine learning models, to generate an initial forecast. In some implementations, the initial forecast may be associated with the second period of time (e.g., the period of time associated with the second portion of historical data).

In some implementations, the forecast analysis platform may generate one or more first initial forecasts using a first set of machine learning models; one or more second initial forecasts using a second set of machine learning models; one or more third initial forecasts using a third set of machine learning model; and/or the like. In this way the forecast analysis platform may generate at least one initial forecast based on the historical transaction data (e.g., at least one initial forecast concerning one or more transaction types associated with the financial transaction account, such as an initial forecast concerning receipts of the financial transaction account, disbursements of the financial transaction account, indirect changes of the financial transaction account, and/or the like); at least one second initial forecast based on the historical data concerning the one or more parameters (e.g., at least one initial forecast concerning an ending cash value associated with the financial transaction account, at least one initial forecast concern a transaction amount associated with the financial transaction account, and/or the like); a third initial forecast based on the historical transaction data and the historical data concerning the one or more parameters (e.g., at least one initial forecast concerning an ending disbursement value of the financial transaction account and/or the like); and/or the like.

As shown by reference number 110, the forecast analysis platform may evaluate the one or more initial forecasts. The forecast analysis platform may compare the one or more initial forecasts and the second portion of historical data to evaluate the one or more initial forecasts (e.g., because the one or more or more initial forecasts predict some or all of the information that is included in the second portion of historical data). For example, for one or more initial forecasts concerning one or more transaction types associated with the financial transaction account, the forecast analysis platform may compare the one or more initial forecasts and a second portion of the historical transaction data. As another example, for one or more initial forecasts concerning a parameter associated with the financial transaction account, the forecast analysis platform may compare the one or more initial forecasts and a second portion of the historical data concerning the one or more parameters.

In some implementations, to compare the one or more initial forecasts and the second portion of historical data, the forecast analysis platform may use a root mean square error processing technique; a mean square error processing technique; a weighted root mean square error technique; a percentage error technique; a mean absolute error technique; a mean percentage error technique; and/or the like. Moreover, the forecast analysis platform may generate one or more evaluation scores based on comparing the one or more initial forecasts and the second portion of historical data. Each evaluation score may be respectively associated with an initial forecast of the one or more initial forecasts. An evaluation score may have a value that indicates a degree of fit of a respective initial forecast to the second portion of historical data. For example, an evaluation score may have a value range from 0 to 1, where a low value (e.g., greater than or equal to 0 and less than 0.5) indicates a low degree of fit and a high value (e.g., greater than or equal to 0.5 and less than or equal to 1) indicates a high degree of fit. When an evaluation score is associated with a financial transaction account, the evaluation score may be referred to herein as a forecasted financial score (e.g., a required cash score).

As shown by reference number 112, the forecast analysis platform may select a set of initial forecasts of the one or more initial forecasts. In some implementations, the set of initial forecasts may include an initial forecast of a first type, an initial forecast of a second type, an initial forecast of a third type, and/or the like. For example, the set of initial forecasts may include an initial forecast concerning a transaction type associated with the financial transaction account, an initial forecast concerning a first parameter associated with the financial transaction account, an initial forecast concerning a second parameter associated with the financial transaction account, and/or the like.

For each initial forecast type, the forecast analysis platform may identify and/or determine a particular initial forecast, of the one or more initial forecasts associated with the initial forecast type, with the best fit. For example, the forecast analysis platform may determine that a particular evaluation score, of the one or more evaluation scores associated with the initial forecast type, has a highest overall value. This may indicate a highest degree of fit, a best fit, an optimal fit, and/or the like with the second portion of historical data. Accordingly, the forecast analysis platform may identify and/or determine a particular initial forecast, of the one or more initial forecasts with the initial forecast type, that is associated with the particular evaluation score. In this way, the forecast analysis platform may select a set of initial forecasts that includes one or more initial forecasts of different initial forecast types, where each initial forecast, of the set of initial forecasts, has a highest degree of fit for the initial forecast type of the initial forecast. Additionally, or alternatively, the forecast analysis platform may select and/or determine a set of machine learning models that includes one or more machine learning models that are respectively associated with the one or more initial forecasts.

As shown in FIG. 1C and by reference number 114, the forecast analysis platform may identify a particular parameter for further forecasting. For example, when the transaction account is a financial transaction account, the forecast analysis platform may identify the ending cash value associated with the financial transaction account as the particular parameter. As another example, the forecast analysis platform may identify the transaction amount associated with the financial transaction account as the particular parameter.

As shown by reference number 116, the forecast analysis platform may generate, select, identify, and/or determine one or more forecasts (shown in FIG. 1C as forecasts 1 through N, where N is greater than or equal to 1) concerning the particular parameter (e.g., based on the set of initial forecasts). For example, when the set of initial forecasts includes an initial forecast concerning the particular parameter (e.g., the ending cash value), the forecast analysis platform may select and/or identify the initial forecast as a forecast of the one or more forecasts.

In another example, when the set of initial forecasts includes an initial forecast concerning a parameter (e.g., the transaction amount) that is different than the particular parameter (e.g., the ending cash value), the forecast analysis platform may identify one or more predicted parameter values (e.g., one or more predicted transaction amount values) in the initial forecast concerning the different parameter. Accordingly, the forecast analysis platform may determine, based on the one or more predicted parameter values, one or more predicted particular parameter values (e.g., the forecast analysis platform may determine one or more predicted ending cash values based on the one or more predicted transaction amount values). The forecast analysis platform therefore may generate a forecast to include the one or more predicted particular parameter values.

In an additional example, when the set of initial forecasts includes an initial forecast concerning transaction data, the forecast analysis platform may identify one or more periods of time associated with the initial forecast (e.g., one or more dates associated with the initial forecast). The forecast analysis platform may identify, for each period of time, one or more respective predicted transaction values included in the initial forecast (e.g., one or more respective predicted transaction values for each date). Accordingly, the forecast analysis platform may determine, for each period of time, a respective predicted particular parameter value by combining (e.g., summing, averaging, weighted summing, weighted averaging, and/or the like) the one or more respective predicted transaction values (e.g., determining a respective predicted ending cash value, for a date, by combining respective predicted receipt values, respective predicted disbursement values, and/or the like). The forecast analysis platform therefore may generate a forecast to include the respective predicted particular parameter value associated with each period of time.

In a further example, when the set of initial forecasts includes an initial forecast concerning transaction data, the forecast analysis platform may process the initial forecast, the historical transaction data, and/or the historical data concerning the one or more parameters (e.g., obtained by the forecast analysis platform from the server device) to train an additional machine learning model (e.g., a machine learning model that utilizes a SARIMAX technique where the initial forecast is input as an exogenous variable) to generate a forecast concerning the particular parameter. Accordingly, the forecast analysis platform may process, using the machine learning model, the initial forecast, the historical transaction data, and/or the historical data concerning the one or more parameters to generate a forecast concerning the particular parameter.

As shown by reference number 118, the forecast analysis platform may evaluate the one or more forecasts concerning the particular parameter. For example, the forecast analysis platform may compare the one or more forecasts and evaluation data to evaluate the one or more forecasts. In some implementations, to compare the one or more forecasts and the evaluation data, the forecast analysis platform may use a root mean square error processing technique; a mean square error processing technique; a weighted root mean square error technique; a percentage error technique; a mean absolute error technique; a mean percentage error technique; and/or the like.

In some implementations, the forecast analysis platform may determine and/or identify the evaluation data based on the historical data. For example, as described herein in relation to FIG. 1B, the forecast analysis platform may divide the historical data into a first portion of historical data and a second portion of historical data. The first portion of historical data may be used to train the one or more machine learning models. Accordingly, the forecast analysis platform may use the second portion of historical data as the evaluation data and/or may process the second portion of historical data to determine the evaluation data.

In some implementations, the forecast analysis platform may process the one or more forecasts to generate one or more evaluation scores (e.g., based on the evaluation data). Each evaluation score may be respectively associated with a forecast of the one or more forecasts. An evaluation score may have a value that indicates a degree of fit of a respective forecast to the evaluation data. For example, an evaluation score may have a value range from 0 to 1, where a low value (e.g., greater than or equal to 0 and less than 0.5) indicates a low degree of fit and a high value (e.g., greater than or equal to 0.5 and less than or equal to 1) indicates a high degree of fit.

As shown in FIG. 1D and by reference number 120, the forecast analysis platform may identify and/or determine a particular forecast, of the one or more forecasts, with the best fit. For example, the forecast analysis platform may determine that a particular evaluation score, of the one or more evaluation scores, has a highest overall value. This may indicate a highest degree of fit, a best fit, an optimal fit, and/or the like with the evaluation data. Accordingly, the forecast analysis platform may identify and/or determine a particular forecast, of the one or more forecasts, that is associated with the particular evaluation score.

As shown by reference number 122, the forecast analysis platform may identify and/or determine at least one machine learning model, of the one or more machine learning models, that is associated with the particular forecast (e.g., select an optimum at least one machine learning model). In some implementations, the forecast analysis platform may retrain and/or update the at least one machine learning model. For example, the forecast analysis platform may retrain and/or update the at least one machine learning model using the second portion of historical data.

As shown by reference number 124, the forecast analysis platform may generate an additional forecast (e.g., concerning the particular parameter) using the at least one machine learning model. The forecast analysis platform may generate the additional forecast using the at least one machine learning model after updating the machine learning model. The forecast analysis platform may process the first portion of historical data and/or the second portion of historical data using the at least one machine learning model to generate the additional forecast. The additional forecast may include one or more forecast values concerning the parameter that are each respectively associated with a period of time (e.g., one or more predicted ending cash values respectively associated with a day, a week, a month, a quarter, and/or the like).

As shown in FIG. 1E and by reference number 126, the forecast analysis platform may perform one or more actions (e.g., based on generating the additional forecast). For example, the forecast analysis platform may generate analysis data concerning a performance of the at least one machine learning model. The forecast analysis platform may compare the additional forecast to actual data to generate the analysis data (e.g., compare a predicated ending cash value for a particular date with an actual ending cash value for the particular date). The forecast analysis platform may use the analysis data to analyze a performance of the at least one machine learning model and/or to update or modify the additional forecast.

In another example, the forecast analysis platform may send the additional forecast and/or the analysis data to a client device to allow the client device to display the additional forecast and/or the analysis data on a display of the client device. In this way, a user of the client device may be able to visually analyze the additional forecast and the analysis data to evaluate a performance of the at least one machine learning model.

In a further example, the forecast analysis platform may update and/or retrain the at least one machine learning model (e.g., based on the performance of the machine learning model). The forecast analysis platform may process the historical data, the additional forecast, and/or the analysis data to update and/or retrain the at least one machine learning model, which may improve operation of the at least one machine learning model. In an additional example, the forecast analysis platform may cause one or more transactions concerning the transaction account to be scheduled. For instance, the forecast analysis platform may determine, based on the additional forecast, that an ending cash balance of the financial transaction account may be lower or higher than is desired on a particular date and may automatically schedule a transaction to transfer cash to or from the financial transaction account prior to the particular date. This may allow for automatic management of the financial transaction account, which may reduce a need to use resources (e.g., processing resources, memory resources, power resources, networking resources, and/or the like) of one or more devices that would otherwise be needed to monitor and manage the financial transaction account.

As indicated above, FIGS. 1A-1E are provided merely as an example. Other examples may differ from what is described with regard to FIGS. 1A-1E.

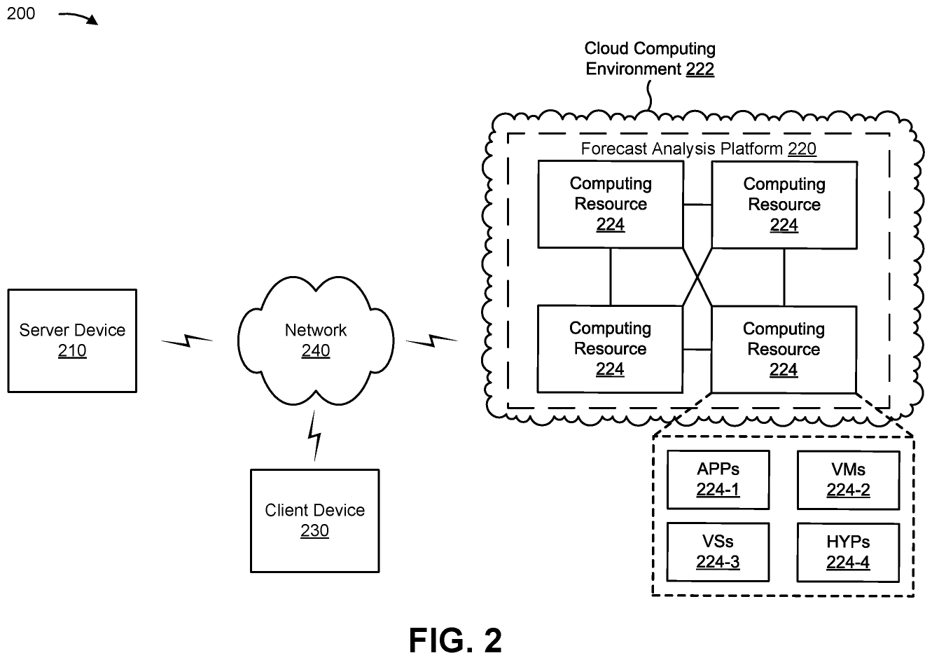

FIG. 2 is a diagram of an example environment 200 in which systems and/or methods described herein may be implemented. As shown in FIG. 2, environment 200 may include a server device 210, a forecast analysis platform 220 in a cloud computing environment 222 that includes computing resources 224, a client device 230, a network 240, and/or the like. Devices of environment 200 may interconnect via wired connections, wireless connections, or a combination of wired and wireless connections.

Server device 210 includes one or more devices capable of receiving, generating, storing, processing, and/or providing information, such as information described herein. For example, server device 210 may include a laptop computer, a tablet computer, a desktop computer, a server, a group of servers, or a similar type of device. In some implementations, server device 210 may receive information from and/or transmit information to forecast analysis platform 220, client device 230, and/or the like.

Forecast analysis platform 220 includes one or more devices that may optimize generation of forecast. In some implementations, forecast analysis platform 220 may be modular such that certain software components may be swapped in or out depending on a particular need. As such, forecast analysis platform 220 may be easily and/or quickly reconfigured for different uses. In some implementations, forecast analysis platform 220 may receive information from and/or transmit information server device 210, client device 230, and/or the like.

In some implementations, as shown, forecast analysis platform 220 may be hosted in a cloud computing environment 222. Notably, while implementations described herein describe forecast analysis platform 220 as being hosted in cloud computing environment 222, in some implementations, forecast analysis platform 220 may be non-cloud-based (i.e., may be implemented outside of a cloud computing environment) or may be partially cloud-based.

Cloud computing environment 222 includes an environment that may host forecast analysis platform 220. Cloud computing environment 222 may provide computation, software, data access, storage, etc. services that do not require end-user knowledge of a physical location and configuration of system(s) and/or device(s) that host forecast analysis platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host forecast analysis platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by client device 230. Application 224-1 may eliminate a need to install and execute the software applications on client device 230. For example, application 224-1 may include software associated with forecast analysis platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program and may support a single process. In some implementations, virtual machine 224-2 may execute on behalf of a user (e.g., a user of server device 210 and/or client device 230 or an operator of forecast analysis platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may provide administrators of the storage system with flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems and may manage the execution of the guest operating systems. Multiple instances of a variety of operating systems may share virtualized hardware resources.

Client device 230 includes one or more devices capable of receiving, generating, storing, processing, and/or providing information, such as information described herein. For example, client device 230 may include a computer (e.g., a desktop computer, a laptop computer, a tablet computer, a handheld computer, a server device, etc.), a mobile phone (e.g., a smart phone, a radiotelephone, etc.), an internet of things (IoT) device or smart appliance, or a similar device. In some implementations, client device 230 may receive information from and/or transmit information to server device 210, forecast analysis platform 220, and/or the like.

Network 240 includes one or more wired and/or wireless networks. For example, network 240 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device and/or a single device shown in FIG. 2 may be implemented as multiple, distributed devices. Additionally, or alternatively, a set of devices (e.g., one or more devices) of environment 200 may perform one or more functions described as being performed by another set of devices of environment 200.

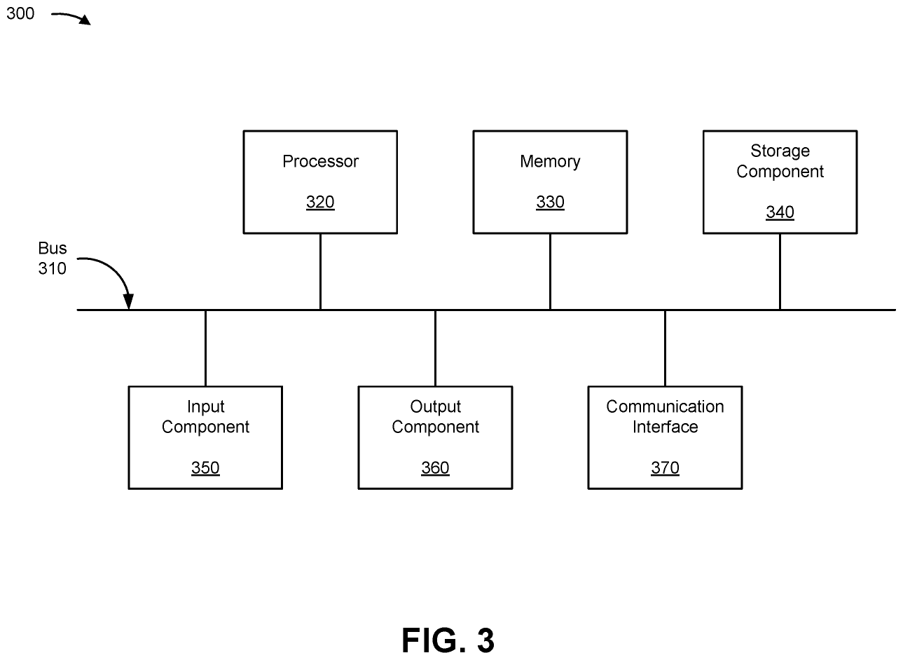

FIG. 3 is a diagram of example components of a device 300. Device 300 may correspond to server device 210, forecast analysis platform 220, computing resource 224, and/or client device 230. In some implementations, server device 210, forecast analysis platform 220, computing resource 224, and/or client device 230 may include one or more devices 300 and/or one or more components of device 300. As shown in FIG. 3, device 300 may include a bus 310, a processor 320, a memory 330, a storage component 340, an input component 350, an output component 360, and/or a communication interface 370.

Bus 310 includes a component that permits communication among multiple components of device 300. Processor 320 is implemented in hardware, firmware, and/or a combination of hardware and software. Processor 320 takes the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

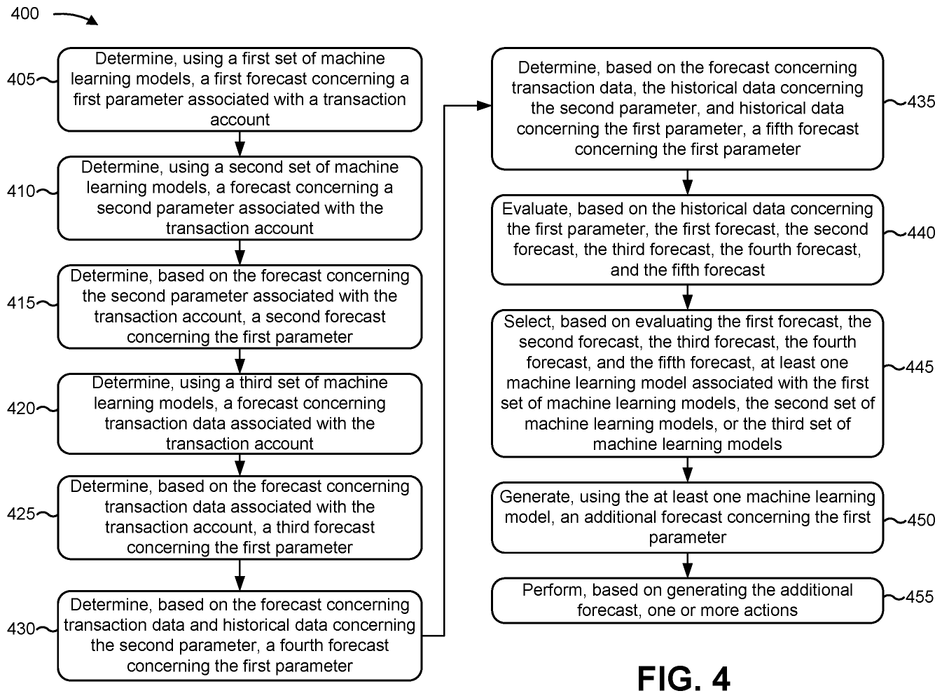

FIG. 4 is a flow chart of an example process 400 for optimizing generation of a forecast. In some implementations, one or more process blocks of FIG. 4 may be performed by a device (e.g., forecast analysis platform 220). In some implementations, one or more process blocks of FIG. 4 may be performed by another device or a group of devices separate from or including the device, such as a server device (e.g., server device 210), a client device (e.g., client device 230), and/or the like.

As shown in FIG. 4, process 400 may include determining, using a first set of machine learning models, a first forecast concerning a first parameter associated with a transaction account (block 405). For example, the device (e.g., using computing resource 224, processor 320, memory 330, storage component 340, input component 350, output component 360, communication interface 370, and/or the like) may determine, using a first set of machine learning models, a first forecast concerning a first parameter associated with a transaction account, as described above.

As further shown in FIG. 4, process 400 may include determining, using a second set of machine learning models, a forecast concerning a second parameter associated with the transaction account (block 410). For example, the device (e.g., using computing resource 224, processor 320, memory 330, storage component 340, input component 350, output component 360, communication interface 370, and/or the like) may determine, using a second set of machine learning models, a forecast concerning a second parameter associated with the transaction account, as described above.

As further shown in FIG. 4, process 400 may include determining, based on the forecast concerning the second parameter associated with the transaction account, a second forecast concerning the first parameter (block 415). For example, the device (e.g., using computing resource 224, processor 320, memory 330, storage component 340, input component 350, output component 360, communication interface 370, and/or the like) may determine, based on the forecast concerning the second parameter associated with the transaction account, a second forecast concerning the first parameter, as described above.

As further shown in FIG. 4, process 400 may include determining, using a third set of machine learning models, a forecast concerning transaction data associated with the transaction account (block 420). For example, the device (e.g., using computing resource 224, processor 320, memory 330, storage component 340, input component 350, output component 360, communication interface 370, and/or the like) may determine, using a third set of machine learning models, a forecast concerning transaction data associated with the transaction account, as described above.

As further shown in FIG. 4, process 400 may include determining, based on the forecast concerning transaction data associated with the transaction account, a third forecast concerning the first parameter (block 425). For example, the device (e.g., using computing resource 224, processor 320, memory 330, storage component 340, input component 350, output component 360, communication interface 370, and/or the like) may determine, based on the forecast concerning transaction data associated with the transaction account, a third forecast concerning the first parameter, as described above.

As further shown in FIG. 4, process 400 may include determining, based on the forecast concerning transaction data and historical data concerning the second parameter, a fourth forecast concerning the first parameter (block 430). For example, the device (e.g., using computing resource 224, processor 320, memory 330, storage component 340, input component 350, output component 360, communication interface 370, and/or the like) may determine, based on the forecast concerning transaction data and historical data concerning the second parameter, a fourth forecast concerning the first parameter, as described above.

As further shown in FIG. 4, process 400 may include determining, based on the forecast concerning transaction data, the historical data concerning the second parameter, and historical data concerning the first parameter, a fifth forecast concerning the first parameter (block 435). For example, the device (e.g., using computing resource 224, processor 320, memory 330, storage component 340, input component 350, output component 360, communication interface 370, and/or the like) may determine, based on the forecast concerning transaction data, the historical data concerning the second parameter, and historical data concerning the first parameter, a fifth forecast concerning the first parameter, as described above.

As further shown in FIG. 4, process 400 may include evaluating, based on the historical data concerning the first parameter, the first forecast, the second forecast, the third forecast, the fourth forecast, and the fifth forecast (block 440). For example, the device (e.g., using computing resource 224, processor 320, memory 330, storage component 340, input component 350, output component 360, communication interface 370, and/or the like) may evaluate, based on the historical data concerning the first parameter, the first forecast, the second forecast, the third forecast, the fourth forecast, and the fifth forecast, as described above.

As further shown in FIG. 4, process 400 may include selecting, based on evaluating the first forecast, the second forecast, the third forecast, the fourth forecast, and the fifth forecast, at least one machine learning model associated with the first set of machine learning models, the second set of machine learning models, or the third set of machine learning models (block 445). For example, the device (e.g., using computing resource 224, processor 320, memory 330, storage component 340, input component 350, output component 360, communication interface 370, and/or the like) may select, based on evaluating the first forecast, the second forecast, the third forecast, the fourth forecast, and the fifth forecast, at least one machine learning model associated with the first set of machine learning models, the second set of machine learning models, or the third set of machine learning models, as described above.

As further shown in FIG. 4, process 400 may include generating, using the at least one machine learning model, an additional forecast concerning the first parameter (block 450). For example, the device (e.g., using computing resource 224, processor 320, memory 330, storage component 340, input component 350, output component 360, communication interface 370, and/or the like) may generate, using the at least one machine learning model, an additional forecast concerning the first parameter, as described above.

As further shown in FIG. 4, process 400 may include performing, based on generating the additional forecast, one or more actions (block 455). For example, the device (e.g., using computing resource 224, processor 320, memory 330, storage component 340, input component 350, output component 360, communication interface 370, and/or the like) may perform, based on generating the additional forecast, one or more actions, as described above.

Process 400 may include additional implementations, such as any single implementation or any combination of implementations described below and/or in connection with one or more other processes described elsewhere herein.

In a first implementation, determining the first forecast comprises: obtaining the historical data concerning the first parameter from a data structure; processing a first portion of the historical data concerning the first parameter to train one or more machine learning models of the first set of machine learning models, the first portion of the historical data concerning the first parameter is associated with a first period of time; generating, using the one or more machine learning models, one or more forecasts concerning the first parameter that are associated with a second period of time; generating, based on a second portion of the historical data concerning the first parameter and the one or more forecasts, one or more evaluation scores, wherein each evaluation score, of the one or more evaluation scores, is respectively associated with a forecast of the one or more forecasts, wherein the second portion of the historical data concerning the first parameter is associated with the second period of time; and determining which forecast, of the one or more forecasts, is associated with an evaluation score, of the one or more evaluation scores, that indicates an optimal fit with the second portion of the historical data.

In a second implementation, alone or in combination with the first implementation, determining the second forecast comprises: identifying one or more predicted second parameter values included in the forecast concerning the second parameter; determining, based on the one or more predicted second parameter values, one or more predicted first parameter values; and generating, based on the one or more predicted first parameter values, the second forecast.

In a third implementation, alone or in combination with one or more of the first and second implementations, determining the third forecast comprises: identifying one or more periods of time associated with the forecast concerning transaction data; identifying, for each period of time of the one or more periods of time, one or more respective predicted transaction values included in the forecast concerning transaction data; determining, for each period of time of the one or more periods of time, a respective predicted first parameter value associated with the period of time by combining the one or more respective predicted transaction values; and generating, based on the respective predicted first parameter value associated with each period of time of the one or more periods of time, the third forecast.

In a fourth implementation, alone or in combination with one or more of the first through third implementations, determining the fourth forecast comprises processing the forecast concerning transaction data and the historical data concerning the second parameter to train a particular machine learning model and generating the fourth forecast using the particular machine learning model.

In a fifth implementation, alone or in combination with one or more of the first through fourth implementations, determining the fifth forecast comprises processing the forecast concerning transaction data, the historical data concerning the second parameter, and the historical data concerning the first parameter using a machine learning model that utilizes a seasonal autoregressive integrated moving average with exogenous variables (SARIMAX) technique to determine the fifth forecast.

In a sixth implementation, alone or in combination with one or more of the first through fifth implementations, evaluating the first forecast, the second forecast, the third forecast, the fourth forecast, and the fifth forecast comprises: generating, based on the historical data concerning the first parameter, one or more evaluation scores, wherein each evaluation score, of the one or more evaluation scores, is respectively associated with the first forecast, the second forecast, the third forecast, the fourth forecast, or the fifth forecast, wherein an evaluation score indicates a degree of fit of a forecast with the historical data concerning the first parameter, and determining a particular evaluation score, of the one or more evaluation scores, that indicates a highest degree of fit.

In a seventh implementation, alone or in combination with one or more of the first through sixth implementations, selecting the at least one machine learning model comprises identifying a particular forecast, of the first forecast, the second forecast, the third forecast, the fourth forecast, and the fifth forecast, that is associated with the particular evaluation score and determining that the at least one machine learning model, of the first set of machine learning models, the second set of machine learning models, or the third set of machine learning models, is associated with generating the particular forecast.

In an eighth implementation, alone or in combination with one or more of the first through seventh implementations, the one or more actions comprise at least one of: sending the additional forecast to an additional device to allow the additional device to display the additional forecast on a display of the additional device; generating, based on the additional forecast, analysis data concerning a performance of the at least one machine learning model; sending the analysis data to the additional device to allow the additional device to display the analysis data on the display of the additional device; causing, based on the additional forecast, one or more transactions concerning the transaction account to be scheduled; or retraining the at least one machine learning model based on the performance of the at least one machine learning model.

In a ninth implementation, alone or in combination with one or more of the first through eighth implementations, the transaction account is a financial transaction account, the first parameter is an ending cash balance of the financial transaction account, and the second parameter is a transaction amount of the financial transaction account.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

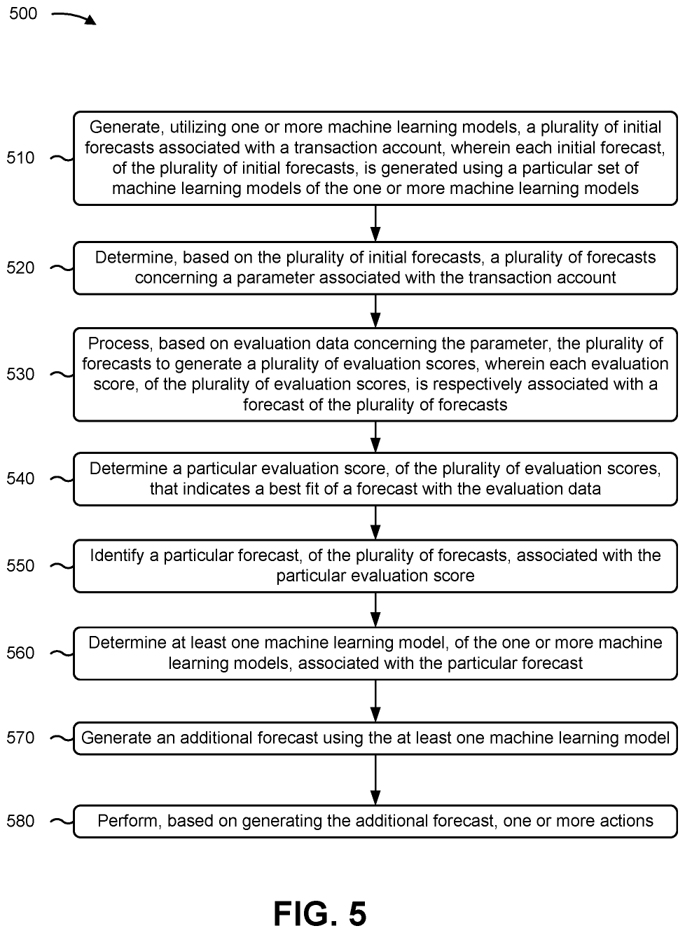

FIG. 5 is a flow chart of an example process 500 for optimizing generation of a forecast. In some implementations, one or more process blocks of FIG. 5 may be performed by a device (e.g., forecast analysis platform 220). In some implementations, one or more process blocks of FIG. 5 may be performed by another device or a group of devices separate from or including the device, such as a server device (e.g., server device 210), a client device (e.g., client device 230), and/or the like.

As shown in FIG. 5, process 500 may include generating, utilizing one or more machine learning models, a plurality of initial forecasts associated with a transaction account, wherein each initial forecast, of the plurality of initial forecasts, is generated using a particular set of machine learning models of the one or more machine learning models (block 510). For example, the device (e.g., using computing resource 224, processor 320, memory 330, storage component 340, input component 350, output component 360, communication interface 370, and/or the like) may generate, utilizing one or more machine learning models, a plurality of initial forecasts associated with a transaction account, as described above. In some implementations, each initial forecast, of the plurality of initial forecasts, is generated using a particular set of machine learning models of the one or more machine learning models.

As further shown in FIG. 5, process 500 may include determining, based on the plurality of initial forecasts, a plurality of forecasts concerning a parameter associated with the transaction account (block 520). For example, the device (e.g., using computing resource 224, processor 320, memory 330, storage component 340, input component 350, output component 360, communication interface 370, and/or the like) may determine, based on the plurality of initial forecasts, a plurality of forecasts concerning a parameter associated with the transaction account, as described above.

As further shown in FIG. 5, process 500 may include processing, based on evaluation data concerning the parameter, the plurality of forecasts to generate a plurality of evaluation scores, wherein each evaluation score, of the plurality of evaluation scores, is respectively associated with a forecast of the plurality of forecasts (block 530). For example, the device (e.g., using computing resource 224, processor 320, memory 330, storage component 340, input component 350, output component 360, communication interface 370, and/or the like) may process, based on evaluation data concerning the parameter, the plurality of forecasts to generate a plurality of evaluation scores, as described above. In some implementations, each evaluation score, of the plurality of evaluation scores, is respectively associated with a forecast of the plurality of forecasts.

As further shown in FIG. 5, process 500 may include determining a particular evaluation score, of the plurality of evaluation scores, that indicates a best fit of a forecast with the evaluation data (block 540). For example, the device (e.g., using computing resource 224, processor 320, memory 330, storage component 340, input component 350, output component 360, communication interface 370, and/or the like) may determine a particular evaluation score, of the plurality of evaluation scores, that indicates a best fit of a forecast with the evaluation data, as described above.

As further shown in FIG. 5, process 500 may include identifying a particular forecast, of the plurality of forecasts, associated with the particular evaluation score (block 550). For example, the device (e.g., using computing resource 224, processor 320, memory 330, storage component 340, input component 350, output component 360, communication interface 370, and/or the like) may identify a particular forecast, of the plurality of forecasts, associated with the particular evaluation score, as described above.

As further shown in FIG. 5, process 500 may include determining at least one machine learning model, of the one or more machine learning models, associated with the particular forecast (block 560). For example, the device (e.g., using computing resource 224, processor 320, memory 330, storage component 340, input component 350, output component 360, communication interface 370, and/or the like) may determine at least one machine learning model, of the one or more machine learning models, associated with the particular forecast, as described above.

As further shown in FIG. 5, process 500 may include generating an additional forecast using the at least one machine learning model (block 570). For example, the device (e.g., using computing resource 224, processor 320, memory 330, storage component 340, input component 350, output component 360, communication interface 370, and/or the like) may generate an additional forecast using the at least one machine learning model, as described above.

As further shown in FIG. 5, process 500 may include performing, based on generating the additional forecast, one or more actions (block 580). For example, the device (e.g., using computing resource 224, processor 320, memory 330, storage component 340, input component 350, output component 360, communication interface 370, and/or the like) may perform, based on generating the additional forecast, one or more actions, as described above.

Process 500 may include additional implementations, such as any single implementation or any combination of implementations described below and/or in connection with one or more other processes described elsewhere herein.

In a first implementation, processing the plurality of forecasts to generate the plurality of evaluation scores uses at least one of: a root mean square error processing technique; a mean square error processing technique; a weighted root mean square error technique; a percentage error technique; a mean absolute error technique; or a mean percentage error technique.

In a second implementation, alone or in combination with the first implementation, the one or more machine learning models include at least one of: a seasonal autoregressive integrated moving average (SARIMA) machine learning model; a seasonal autoregressive integrated moving average with exogenous variables (SARIMAX) machine learning model; a long short-term memory (LSTM) machine learning model; an exponential smoothing machine learning model; a business logic machine learning model; or a naïve machine learning model.

In a third implementation, alone or in combination with one or more of the first and second implementations, process 500 includes obtaining historical transaction data associated with the transaction account and historical data concerning the parameter associated with the transaction account; determining a first set of historical transaction data, of the historical transaction data, and a first set of historical data concerning the parameter, of the historical data concerning the parameter, respectively associated with a first period of time; determining a second set of historical transaction data, of the historical transaction data, and a second set of historical data concerning the parameter, of the historical data concerning the parameter, respectively associated with a second period of time; processing the first set of historical transaction data or the first set of historical data concerning the parameter to train the one or more machine learning models; and processing the second set of historical transaction data or the second set of historical data concerning the parameter to determine the evaluation data.

In a fourth implementation, alone or in combination with one or more of the first through third implementations, the plurality of forecasts and the evaluation data are respectively associated with a period of time and process 500 further includes training the one or more machine learning models using historical data associated with a different period of time, and updating, after determining the at least one machine learning model associated with the particular forecast, the at least one machine learning model using historical data associated with the period of time.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

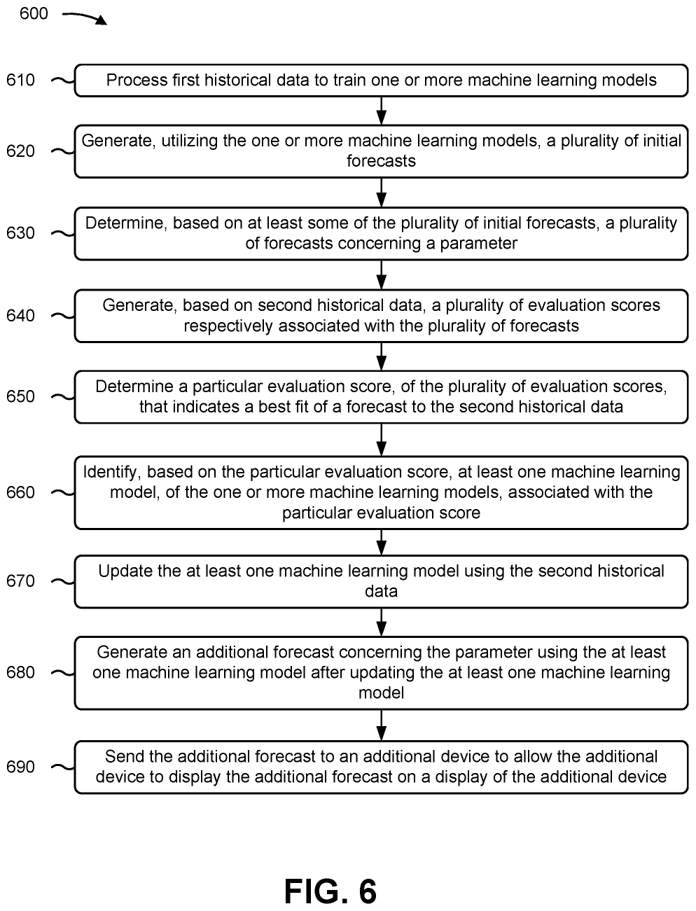

FIG. 6 is a flow chart of an example process 600 for optimizing generation of a forecast. In some implementations, one or more process blocks of FIG. 6 may be performed by a device (e.g., forecast analysis platform 220). In some implementations, one or more process blocks of FIG. 6 may be performed by another device or a group of devices separate from or including the device, such as a server device (e.g., server device 210), a client device (e.g., client device 230), and/or the like.

As shown in FIG. 6, process 600 may include processing first historical data to train one or more machine learning models (block 610). For example, the device (e.g., using computing resource 224, processor 320, memory 330, storage component 340, input component 350, output component 360, communication interface 370, and/or the like) may process first historical data to train one or more machine learning models, as described above.

As further shown in FIG. 6, process 600 may include generating, utilizing the one or more machine learning models, a plurality of initial forecasts (block 620). For example, the device (e.g., using computing resource 224, processor 320, memory 330, storage component 340, input component 350, output component 360, communication interface 370, and/or the like) may generate, utilizing the one or more machine learning models, a plurality of initial forecasts, as described above.

As further shown in FIG. 6, process 600 may include determining, based on at least some of the plurality of initial forecasts, a plurality of forecasts concerning a parameter (block 630). For example, the device (e.g., using computing resource 224, processor 320, memory 330, storage component 340, input component 350, output component 360, communication interface 370, and/or the like) may determine, based on at least some of the plurality of initial forecasts, a plurality of forecasts concerning a parameter, as described above.

As further shown in FIG. 6, process 600 may include generating, based on second historical data, a plurality of evaluation scores respectively associated with the plurality of forecasts (block 640). For example, the device (e.g., using computing resource 224, processor 320, memory 330, storage component 340, input component 350, output component 360, communication interface 370, and/or the like) may generate, based on second historical data, a plurality of evaluation scores respectively associated with the plurality of forecasts, as described above.

As further shown in FIG. 6, process 600 may include determining a particular evaluation score, of the plurality of evaluation scores, that indicates a best fit of a forecast to the second historical data (block 650). For example, the device (e.g., using computing resource 224, processor 320, memory 330, storage component 340, input component 350, output component 360, communication interface 370, and/or the like) may determine a particular evaluation score, of the plurality of evaluation scores, that indicates a best fit of a forecast to the second historical data, as described above.

As further shown in FIG. 6, process 600 may include identifying, based on the particular evaluation score, at least one machine learning model, of the one or more machine learning models, associated with the particular evaluation score (block 660). For example, the device (e.g., using computing resource 224, processor 320, memory 330, storage component 340, input component 350, output component 360, communication interface 370, and/or the like) may identify, based on the particular evaluation score, at least one machine learning model, of the one or more machine learning models, associated with the particular evaluation score, as described above.

As further shown in FIG. 6, process 600 may include updating the at least one machine learning model using the second historical data (block 670). For example, the device (e.g., using computing resource 224, processor 320, memory 330, storage component 340, input component 350, output component 360, communication interface 370, and/or the like) may update the at least one machine learning model using the second historical data, as described above.

As further shown in FIG. 6, process 600 may include generating an additional forecast concerning the parameter using the at least one machine learning model after updating the at least one machine learning model (block 680). For example, the device (e.g., using computing resource 224, processor 320, memory 330, storage component 340, input component 350, output component 360, communication interface 370, and/or the like) may generate an additional forecast concerning the parameter using the at least one machine learning model after updating the at least one machine learning model, as described above.

As further shown in FIG. 6, process 600 may include sending the additional forecast to an additional device to allow the additional device to display the additional forecast on a display of the additional device (block 690). For example, the device (e.g., using computing resource 224, processor 320, memory 330, storage component 340, input component 350, output component 360, communication interface 370, and/or the like) may send the additional forecast to an additional device to allow the additional device to display the additional forecast on a display of the additional device, as described above.

Process 600 may include additional implementations, such as any single implementation or any combination of implementations described below and/or in connection with one or more other processes described elsewhere herein.

In a first implementation, a weighted root mean square error technique is utilized to generate the plurality of evaluation scores.

In a second implementation, alone or in combination with the first implementation, when generating the additional forecast using the at least one machine learning model, process 600 includes processing, after updating the at least one machine learning model, the first historical data and the second historical data using the at least one machine learning model to generate the additional forecast.

In a third implementation, alone or in combination with one or more of the first and second implementations, the first historical data includes historical transaction data and historical data concerning the parameter respectively associated with a transaction account. When generating the plurality of initial forecasts associated with the transaction account, process 600 includes generating a first initial forecast, of the plurality of initial forecasts, based on the historical transaction data; generating a second initial forecast, of the plurality of initial forecasts, based on the historical data concerning the parameter, and generating a third initial forecast, of the plurality of initial forecasts, based on the historical transaction data and the historical data concerning the parameter.

In a fourth implementation, alone or in combination with one or more of the first through third implementations, the additional forecast includes one or more forecast values concerning the parameter that are each respectively associated with a period of time.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

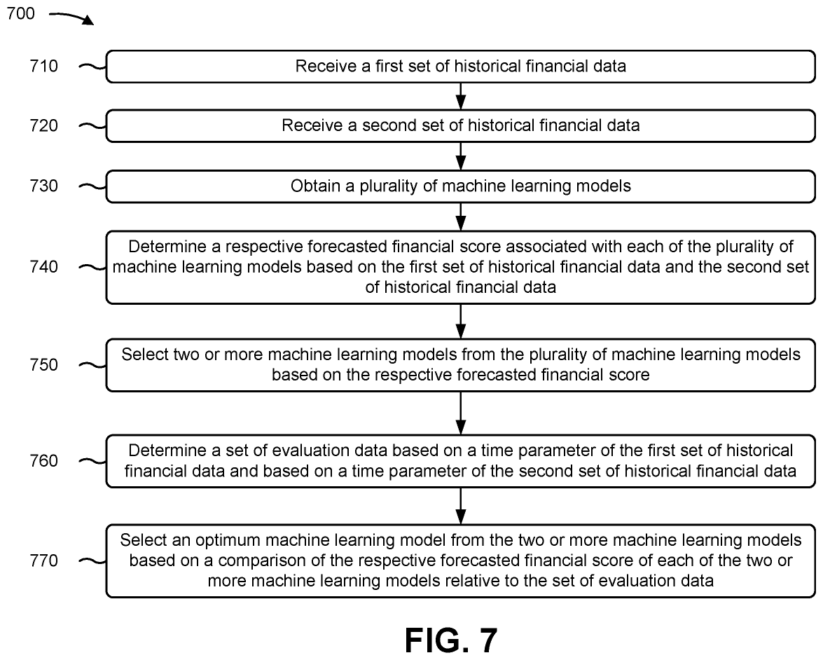

FIG. 7 is a flow chart of an example process 700 for optimizing generation of a forecast. In some implementations, one or more process blocks of FIG. 7 may be performed by a device (e.g., forecast analysis platform 220). In some implementations, one or more process blocks of FIG. 7 may be performed by another device or a group of devices separate from or including the device, such as a server device (e.g., server device 210), a client device (e.g., client device 230), and/or the like.

As shown in FIG. 7, process 700 may include receiving a first set of historical financial data (block 710). For example, the device (e.g., using computing resource 224, processor 320, memory 330, storage component 340, input component 350, output component 360, communication interface 370, and/or the like) may receive a first set of historical financial data, as described above.

As further shown in FIG. 7, process 700 may include receiving a second set of historical financial data (block 720). For example, the device (e.g., using computing resource 224, processor 320, memory 330, storage component 340, input component 350, output component 360, communication interface 370, and/or the like) may receive a second set of historical financial data, as described above.

As further shown in FIG. 7, process 700 may include obtaining a plurality of machine learning models (block 730). For example, the device (e.g., using computing resource 224, processor 320, memory 330, storage component 340, input component 350, output component 360, communication interface 370, and/or the like) may obtain a plurality of machine learning models, as described above.

As further shown in FIG. 7, process 700 may include determining a respective forecasted financial score associated with each of the plurality of machine learning models based on the first set of historical financial data and the second set of historical financial data (block 740). For example, the device (e.g., using computing resource 224, processor 320, memory 330, storage component 340, input component 350, output component 360, communication interface 370, and/or the like) may determine a respective forecasted financial score associated with each of the plurality of machine learning models based on the first set of historical financial data and the second set of historical financial data, as described above.

As further shown in FIG. 7, process 700 may include selecting two or more machine learning models from the plurality of machine learning models based on the respective forecasted financial score (block 750). For example, the device (e.g., using computing resource 224, processor 320, memory 330, storage component 340, input component 350, output component 360, communication interface 370, and/or the like) may select two or more machine learning models from the plurality of machine learning models based on the respective forecasted financial score, as described above.

As further shown in FIG. 7, process 700 may include determining a set of evaluation data based on a time parameter of the first set of historical financial data and based on a time parameter of the second set of historical financial data (block 760). For example, the device (e.g., using computing resource 224, processor 320, memory 330, storage component 340, input component 350, output component 360, communication interface 370, and/or the like) may determine a set of evaluation data based on a time parameter of the first set of historical financial data and based on a time parameter of the second set of historical financial data, as described above.

As further shown in FIG. 7, process 700 may include selecting an optimum machine learning model from the two or more machine learning models based on a comparison of the respective forecasted financial score of each of the two or more machine learning models relative to the set of evaluation data (block 770). For example, the device (e.g., using computing resource 224, processor 320, memory 330, storage component 340, input component 350, output component 360, communication interface 370, and/or the like) may select an optimum machine learning model from the two or more machine learning models based on a comparison of the respective forecasted financial score of each of the two or more machine learning models relative to the set of evaluation data, as described above.

Process 700 may include additional implementations, such as any single implementation or any combination of implementations described below and/or in connection with one or more other processes described elsewhere herein.

In a first implementation, process 700 further includes determining a set of training data based on the time parameter of the first set of historical financial data and based on the time parameter of the second set of historical financial data; and training each of the two or more machine learning models based on the set of training data.

In a second implementation, alone or in combination with the first implementation, the first set of historical financial data comprises cash balance data and the second set of historical financial data comprises financial transaction data.

In a third implementation, alone or in combination with one or more of the first and second implementations, a forecasted financial score comprises a required cash score.

In a fourth implementation, alone or in combination with one or more of the first through third implementations, a machine learning model, of the plurality of machine learning models, utilizes a seasonal autoregressive integrated moving average with exogenous variables (SARIMAX) technique.

In a fifth implementation, alone or in combination with one or more of the first through fourth implementations, process 700 further includes generating, using the optimum machine learning model, a forecast; performing, based on generating the forecast, at least one of: sending the forecast to an additional device to allow the additional device to display the forecast on a display of the additional device; generating, based on the forecast, analysis data concerning a performance of the optimum machine learning model; sending the analysis data to the additional device to allow the additional device to display the analysis data on the display of the additional device; or retraining the optimum machine learning model based on the performance of the optimum machine learning model.

In a sixth implementation, alone or in combination with one or more of the first through fifth implementations, determining the respective forecasted financial score associated with each of the plurality of machine learning models uses at least one of a root mean square error processing technique; a mean square error processing technique; a weighted root mean square error technique; a percentage error technique; a mean absolute error technique; or a mean percentage error technique.

In a seventh implementation, alone or in combination with one or more of the first through sixth implementations, the plurality of machine learning models include at least one of a seasonal autoregressive integrated moving average (SARIMA) machine learning model; a seasonal autoregressive integrated moving average with exogenous variables (SARIMAX) machine learning model; a long short-term memory (LSTM) machine learning model; an exponential smoothing machine learning model; a business logic machine learning model; or a naïve machine learning model.

In an eighth implementation, alone or in combination with one or more of the first through seventh implementations, a weighted root mean square error technique is utilized to determine the respective forecasted financial score associated with each of the plurality of machine learning models.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method, comprising:
receiving, by a device, a first set of historical financial data;
receiving, by the device, a second set of historical financial data;
obtaining, by the device, a plurality of machine learning models;
determining, by the device, a respective forecasted financial score associated with each of the plurality of machine learning models based on the first set of historical financial data and the second set of historical financial data,
wherein the first set of historical financial data comprises cash balance data and the second set of historical financial data comprises financial transaction data;
selecting, by the device, two or more machine learning models from the plurality of machine learning models based on the respective forecasted financial score;
determining, by the device, a set of training data based on a time parameter of the first set of historical financial data and based on a time parameter of the second set of historical financial data,
wherein the time parameter of the first set of historical financial data is different from the time parameter of the second set of historical financial data, and
wherein the time parameter of the second set of historical financial data occurs after the time parameter associated with the first set of historical financial data;
training, by the device, each of the two or more machine learning models based on the set of training data;
determining, by the device, a set of evaluation data based on the time parameter of the first set of historical financial data and based on the time parameter of the second set of historical financial data; and
selecting, by the device, an optimum machine learning model from the two or more machine learning models based on a comparison of the respective forecasted financial score of each of the two or more machine learning models relative to the set of evaluation data.

2. (canceled)

3. (canceled)

4. The method of claim 1, wherein a forecasted financial score comprises a required cash score.

5. The method of claim 1, wherein a machine learning model, of the plurality of machine learning models, utilizes a seasonal autoregressive integrated moving average with exogenous variables (SARIMAX) technique.

6. The method of claim 1, further comprising:
generating, using the optimum machine learning model, a forecast;
performing, based on generating the forecast, at least one of:
sending the forecast to an additional device to allow the additional device to display the forecast on a display of the additional device;
generating, based on the forecast, analysis data concerning a performance of the optimum machine learning model;
sending the analysis data to the additional device to allow the additional device to display the analysis data on the display of the additional device; or
retraining the optimum machine learning model based on the performance of the optimum machine learning model.

7. The method of claim 1, wherein determining the respective forecasted financial score associated with each of the plurality of machine learning models uses at least one of:
a root mean square error processing technique;
a mean square error processing technique;
a weighted root mean square error technique;
a percentage error technique;
a mean absolute error technique; or
a mean percentage error technique.

8. The method of claim 1, wherein the plurality of machine learning models include at least one of:
a seasonal autoregressive integrated moving average (SARIMA) machine learning model;
a seasonal autoregressive integrated moving average with exogenous variables (SARIMAX) machine learning model;
a long short-term memory (LSTM) machine learning model;
an exponential smoothing machine learning model;
a business logic machine learning model; or
a naïve machine learning model.

9. The method of claim 1, wherein a weighted root mean square error technique is utilized to determine the respective forecasted financial score associated with each of the plurality of machine learning models.

10. A device, comprising:
one or more memories; and
one or more processors communicatively coupled to the one or more memories, configured to:
receive a first set of historical financial data;
receive a second set of historical financial data;
obtain a plurality of machine learning models;
determine a respective forecasted financial score associated with each of the plurality of machine learning models based on the first set of historical financial data and the second set of historical financial data,
wherein the first set of historical financial data comprises cash balance data and the second set of historical financial data comprises financial transaction data;
select two or more machine learning models from the plurality of machine learning models based on the respective forecasted financial score;
determine a set of training data based on a time parameter of the first set of historical financial data and based on a time parameter of the second set of historical financial data,
wherein the time parameter of the first set of historical financial data is different from the time parameter of the second set of historical financial data, and
wherein the time parameter of the second set of historical financial data occurs after the time parameter associated with the first set of historical financial data;
train each of the two or more machine learning models based on the set of training data;
determine a set of evaluation data based on the time parameter of the first set of historical financial data and based on the time parameter of the second set of historical financial data; and
select an optimum machine learning model from the two or more machine learning models based on a comparison of the respective forecasted financial score of each of the two or more machine learning models relative to the set of evaluation data.

11. (canceled)

12. (canceled)

13. The device of claim 10, wherein a forecasted financial score comprises a required cash score.

14. The device of claim 10, wherein the one or more processors are further configured to:
generate, using the optimum machine learning model, a forecast;
perform, based on generating the forecast, at least one of:
send the forecast to an additional device to allow the additional device to display the forecast on a display of the additional device;
generate, based on the forecast, analysis data concerning a performance of the optimum machine learning model;
send the analysis data to the additional device to allow the additional device to display the analysis data on the display of the additional device; or
retrain the optimum machine learning model based on the performance of the optimum machine learning model.

15. The device of claim 10, wherein determining the respective forecasted financial score associated with each of the plurality of machine learning models uses at least one of:
a root mean square error processing technique;
a mean square error processing technique;
a weighted root mean square error technique;
a percentage error technique;
a mean absolute error technique; or
a mean percentage error technique.

16. A non-transitory computer-readable medium storing instructions, the instructions comprising:
one or more instructions that, when executed by one or more processors, cause the one or more processors to:
receive a first set of historical financial data;
receive a second set of historical financial data;
obtain a plurality of machine learning models;
determine a respective forecasted financial score associated with each of the plurality of machine learning models based on the first set of historical financial data and the second set of historical financial data,
wherein the first set of historical financial data comprises cash balance data and the second set of historical financial data comprises financial transaction data;
select two or more machine learning models from the plurality of machine learning models based on the respective forecasted financial score;
determine a set of training data based on a time parameter of the first set of historical financial data and based on a time parameter of the second set of historical financial data,
wherein the time parameter of the first set of historical financial data is different from the time parameter of the second set of historical financial data, and
wherein the time parameter of the second set of historical financial data occurs after the time parameter associated with the first set of historical financial data;
train each of the two or more machine learning models based on the set of training data;
determine a set of evaluation data based on the time parameter of the first set of historical financial data and based on the time parameter of the second set of historical financial data; and
select an optimum machine learning model from the two or more machine learning models based on a comparison of the respective forecasted financial score of each of the two or more machine learning models relative to the set of evaluation data.

17. (canceled)

18. The non-transitory computer-readable medium of claim 16, wherein a machine learning model, of the plurality of machine learning models, utilizes a seasonal autoregressive integrated moving average with exogenous variables (SARIMAX) technique.

19. The non-transitory computer-readable medium of claim 16, wherein the plurality of machine learning models include at least one of:
a seasonal autoregressive integrated moving average (SARIMA) machine learning model;
a seasonal autoregressive integrated moving average with exogenous variables (SARIMAX) machine learning model;
a long short-term memory (LSTM) machine learning model;
an exponential smoothing machine learning model;
a business logic machine learning model; or
a naïve machine learning model.

20. The non-transitory computer-readable medium of claim 16, wherein a weighted root mean square error technique is utilized to determine the respective forecasted financial score associated with each of the plurality of machine learning models.

21. The method of claim 1, the plurality of machine learning models are trained using a supervised training procedure.

22. The device of claim 10, wherein the one or more processors are further configured to:
perform a multi-layer artificial neural network processing technique to perform pattern recognition associated with patterns in the set of training data.

23. The non-transitory computer-readable medium of claim 16, wherein the one or more instructions, when executed by the one or more processors, further cause the one or more processors to:
receive additional input to the plurality of machine learning models from a subject matter expert.

24. The method of claim 6, further comprising:
updating or modifying the forecast based on the analysis data.

25. The device of claim 14, wherein the one or more processors are further configured to:
update or modify the forecast based on the analysis data.
